(19) United States
(12) Patent Application Publication
(10) Pub. No.: US 2006/0164211 A1
(43) Pub. Date: Jul. 27, 2006

(54) Deliberate Multiple and Consecutive Data Scanning Process

(76) Inventor: Dolphus Jack Brown, Miami, FL (US)

Correspondence Address: DOLPHUS JACK BROWN, 6800 BIRD RD, SUITE 100-48, MIAMI, FL, 33155, US

(21) Appl. No.: 10/905,910

(22) Filed: Jan. 26, 2005

(51) Int. Cl. H04Q 5/22; G06K 7/00; G08B 13/14

(52) U.S. Cl. 340/10.1; 340/572.1; 235/436

(57) ABSTRACT

A process whereby deliberate multiple and consecutive scans or reads of a unique ID Tag such as a barcode or ID chip is used to denote different actions, events, or status concerning the item or person attached to the unique ID Tag.

### BACKGROUND OF THE INVENTION

This invention pertains to the field of data retrieval from static identification data storage devices such as barcodes, chips or buttons, and radio frequency ID (RFID) devices. There are no prior patents relevant to this invention.

### BRIEF SUMMARY OF THE INVENTION

The Deliberate Multiple and Consecutive Data Scanning Process utilizes deliberate multiple and consecutive scans, or reads, of the same ID storage device within a limited period of time to designate different types of actions taken upon, events occurring to, or status of the item or person indicated by the ID storage device.

### DETAILED DESCRIPTION OF THE INVENTION

Hereafter, the name ID Tag shall be taken to mean any unique static identification indicator such as, but not limited to, a barcode, silicon identification chip, or radio frequency identification tag (RFID). The name data collector shall mean any device designed to collect the unique identification indicator from an ID tag.

The Deliberate Multiple and Consecutive Scanning Process entails using deliberate multiple and consecutive scans (or reads) of the same ID Tag within a limited timeframe to denote different actions, events, or status regarding the item, or person, bearing the ID tag. Some examples:

### EXAMPLE 1

One scan may mean that a specific crate is in inventory, two deliberate and consecutive scans might mean that a specific crate is in inventory but that it is damaged, three deliberate and consecutive scans might mean that a specific crate is in inventory but it smells spoiled;

### EXAMPLE 2

One scan might mean only that a security guard visited a specific location on his rounds, two deliberate and consecutive scans might mean that a security guard visited a specific location on his rounds and that the door had been left unlocked;

### EXAMPLE 3

One scan might mean that a unit identified by an ID Tag was serviced, two deliberate and consecutive scans might mean that the unit was delivered, three deliberate and consecutive scans might mean that the unit was picked up.

The determination of the action, event, or status occurring to the item or person identified by this ID Tag is easily determined by a simple visual readout of the scan log, or by parsing the information with a simple computer program.

That the process is useful is self-evident. Although the process is as simple as the idea of the paper clip, it is also novel and non-obvious. ID Tags and their data collection devices have been around for years, but the idea of deliberate multiple and consecutive scans to denote different actions taken upon, events occurring to, or status of an item or person identified by an ID Tag has never been used, nor has anything ever been published on the subject. In fact, most data collection devices come pre-programmed by their manufacturers to not accept duplicate scans of the same ID tag consecutively, or to require some time lapse between scans to prevent erroneous multiple scans.

The most familiar of the ID Tags is the simple barcode; which, along with its scanner, form a system whereby it is noted when the scanner reads the barcode. This information is either stored in the reader until retrieved when it can be determined exactly at what time the read was made; or, if the scanner is connected directly to a computer the read is immediately matched to the item indicated by the barcode. This is possible because barcodes can be unique and thus differentiate between the read of a can of tomatoes or a box of detergent. If you buy two cans of tomatoes each can may be scanned separately, one may be scanned twice, with a sufficient time lapse between scans, or only one scan may be made and the multiple purchases of 2 cans will be entered manually on the cash register. In any event, the same action is simply recorded twice. You bought two cans of tomatoes. It does not distinguish any different action to the cans of tomatoes. All other processes with a simple read of ID Tags are the same. They only relate that one specific action has been taken to the item or location bearing the ID Tag, or that one specific state or status exists.

UPS and other delivery companies use barcodes to track the deliveries of their packages. The barcode is scanned, once, when the package is picked up from the customer and then a code is manually entered on an elaborate handheld scanner to indicate that the package was picked up. At each stage of the progress of the package the barcode is scanned once and then a keyboard on the collection device is used to enter the status; received at the shipping office, loaded on the plane (or truck), received at the shipping destination, on the truck for delivery, and finally, delivered.

Other uses for unique ID Tags are much more extensive than those now in use at retail stores and shipping companies. ID Tags now in use are used to keep track of warehouse inventories, track security guards on their rounds, to clock in and out employees, to track vehicle movements, and much more. In all cases the ID Tag is read once to denote that the item specified by the ID Tag was visited. While this read may denote many different things, it always denotes only one specific thing; i.e. this crate is in inventory, or this crate is damaged, but not both.

What is claimed is:

1. In a data collection system using, but not limited to, unique ID Tags such as barcodes, silicon chips, or radio frequency identification tags; along with data collection devices such as, but not limited to, scanners, probes, readers, or radio frequency data collectors; using deliberate, multiple and consecutive scans or reads of the same unique ID tag within a limited period of time may be used to indicate multiple specific actions taken upon, events occurring to, or status of the item or person to which the unique ID tag is linked.
